(19) United States
(12) Patent Application Publication
(10) Pub. No.: US 2026/0276901 A1
(43) Pub. Date: Sep. 17, 2026

(54) OPTICAL CONNECTOR, FERRULE, AND OPTICAL CONNECTOR MODULE

(71) Applicant: Enplas Corporation, Saitama (JP)

(72) Inventors: Ayano HINATA, Saitama (JP); Masato NAKAMURA, Saitama (JP)

(21) Appl. No.: 18/850,648

(22) PCT Filed: Mar. 15, 2023
(86) PCT No.: PCT/JP2023/010187

§ 371 Date: Sep. 25, 2024

(30) Foreign Application Priority Data
Mar. 31, 2022 (JP) 2022-059175

(51) Int. Cl. G02B 6/38; G02B 6/40

(52) U.S. Cl. CPC G02B 6/3834; G02B 6/3826; G02B 6/403

(57) ABSTRACT

An optical connector has a plurality of optical transmission bodies arranged in parallel in a first direction, and a ferrule that includes a holding part, a first surface and a second surface. A first central axis of the second surface and a second central axis of the optical transmission bodies are located closer to the tip side of the optical transmission bodies than a mating center line of a movement suppression part.

### TECHNICAL FIELD

The present invention relates to an optical connector, a ferrule, and an optical connector module.

### BACKGROUND ART

In the field of optical communication that transmits light emitted from a light emitting element such as a surface emitting laser (for example, a vertical cavity surface emitting laser (VCSEL)), a plurality of optical transmission bodies have been used to expand capacity. Further, ferrules for optically coupling optical transmission bodies to each other is known (see, for example, Patent Literature (hereinafter, abbreviated as PTL) 1).

PTL 1 describes a fiber-attached ferrule including a ferrule having a fiber hole, a lensed fiber to which a GRIN lens is connected at the tip end of an optical fiber, and a flat plate that covers the fiber hole. The flat plate is disposed so as to be inclined with respect to an optical axis of the lensed fiber.

Two fiber-attached ferrules according to PTL 1 are disposed such that flat plates thereof face each other. Light emitted from one lensed fiber is refracted by one of the flat plates and travels toward the other flat plate. The light having reached the other flat plate is refracted at the flat plate and enters the lensed fiber.

### CITATION LIST

### Patent Literature

### PTL 1

Japanese Patent Application Laid-Open No. 2016-184104

### SUMMARY OF INVENTION

### Technical Problem

In the fiber-attached ferrule described in PTL 1, however, the ferrule may be slightly deformed due to a change in the use environment (temperature). Thus, there has been a problem in that the lensed fiber is shifted from the correct position, and the optical coupling efficiency decreases.

An object of the present invention is to provide an optical connector capable of preventing a decrease in optical coupling efficiency even when the optical connector thermally deforms due to a change in the use temperature. Further, another object of the present invention is to provide a ferrule used for the optical connector and an optical connector module.

### Solution to Problem

[1] An optical connector that holds a plurality of optical transmission bodies, the optical connector being configured to engage with another optical connector that holds another plurality of optical transmission bodies to optically couple the plurality of optical transmission bodies with the other plurality of optical transmission bodies, the other optical connector having a shape identical with a shape of the optical connector, the optical connector including: the plurality of optical transmission bodies; and a ferrule that holds the plurality of optical transmission bodies disposed in parallel to each other in a first direction, in which
the ferrule includes: a holding section that holds the plurality of optical transmission bodies, a first surface disposed to face end surfaces of the plurality of optical transmission bodies held by the holding section, the first surface allowing thereon incidence of light emitted from the plurality of optical transmission bodies or allowing therefrom emission of light toward the plurality of optical transmission bodies; and a plurality of second surfaces that allow therefrom emission of the light incident on the first surface toward the other optical connector or allow thereon incidence of light from the other optical connector,
the end surfaces of the plurality of optical transmission bodies are each inclined with respect to a second direction perpendicular to the first direction when the end surfaces are viewed along the first direction,
in a cross section that is along the second direction and includes a first center axis of any one second surface of the plurality of second surfaces and a second center axis of one optical transmission body among the plurality of optical transmission bodies, the one optical transmission body corresponding to the second surface, the first center axis and the second center axis are disposed closer to a tip end of the one optical transmission body than a fitting centerline is, and
under an assumption that the optical connector is engaged with the other optical connector and that the first center axis and the second center axis are positioned on an identical straight line, when a third reference straight line is defined as a straight line positioned on the first center axis and the second center axis at a time when optical coupling efficiency between the plurality of optical transmission bodies and the other plurality of optical transmission bodies is maximized, the third reference straight line is positioned in the cross section between the first center axis and the second center axis.

[2] The optical connector according to [1], in which
the ferrule further includes at least one pair of movement prevention sections for restricting movement with respect to the other optical connector in the second direction perpendicular to the first direction, the at least one pair of movement prevention sections being disposed in positions in such a way that each of the movement prevention sections is linearly symmetrical with respect to a first reference straight line parallel to the first direction when each of the movement prevention sections is viewed along an optical path between the optical connector and the other optical connector, the at least one pair of movement prevention sections being fitted to the other optical connector directly or via another member, and
the fitting centerline is at a center of one of the movement prevention members.

[3] The ferrule used for the optical connector according to [1] or [2].

[4] An optical connector module including: the optical connector according to [1] or [2].

### Advantageous Effects of Invention

According to the present invention, a decrease in the optical coupling efficiency can be prevented even when the optical connector thermally deforms due to a change in the use temperature.

### BRIEF DESCRIPTION OF DRAWINGS

FIGS. 1A and 1B illustrate a configuration of an optical connector according to Embodiment 1;

FIGS. 2A and 2B are other diagrams illustrating the configuration of the optical connector according to Embodiment 1;

FIGS. 3A and 3B are cross-sectional views of the optical connector according to Embodiment 1;

FIGS. 4A and 4B illustrate a configuration of a ferrule excluding a lid;

FIGS. 5A to 5E illustrate a configuration of the lid in Embodiment 1;

FIGS. 6A and 6B are diagrams for describing a relationship between a second surface, an optical transmission body, and a movement prevention section;

FIGS. 7A and 7B are diagrams for describing optical coupling efficiencies of the optical connector in the Example and optical connectors in Comparative Examples 1 and 2;

FIGS. 8A and 8B illustrate a configuration of an optical connector according to Embodiment 2;

FIGS. 9A to 9C are other diagrams illustrating the configuration of the optical connector according to Embodiment 2;

FIGS. 10A and 10B are cross-sectional views of an optical connector according to Embodiment 3;

FIGS. 11A to 11C are other diagrams illustrating a configuration of the optical connector according to Embodiment 3;

FIGS. 12A and 12B are diagrams for describing the relationship between the second surface, the optical transmission body, and the movement prevention section;

FIGS. 13A and 13B are cross-sectional views of an optical connector according to Embodiment 4;

FIGS. 14A to 14C are other diagrams illustrating the configuration of the optical connector according to Embodiment 4; and

FIG. 15 is a diagram for describing a method for using (using method of) an optical connector according to Embodiment 5.

### DESCRIPTION OF EMBODIMENTS

Hereinafter, an optical connector according to an embodiment of the present invention will be described in detail with reference to the accompanying drawings.

### Embodiment 1

### Configuration of Optical Connector

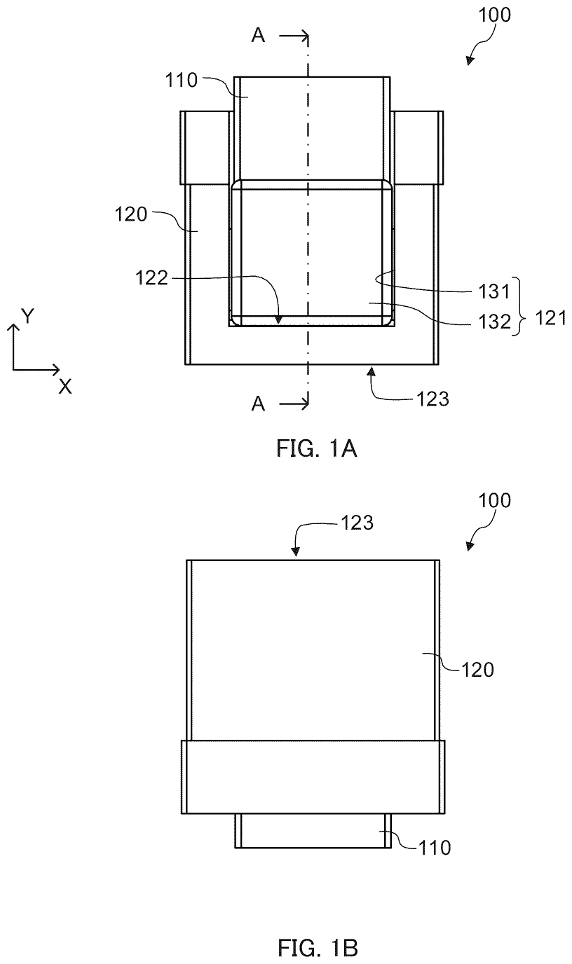

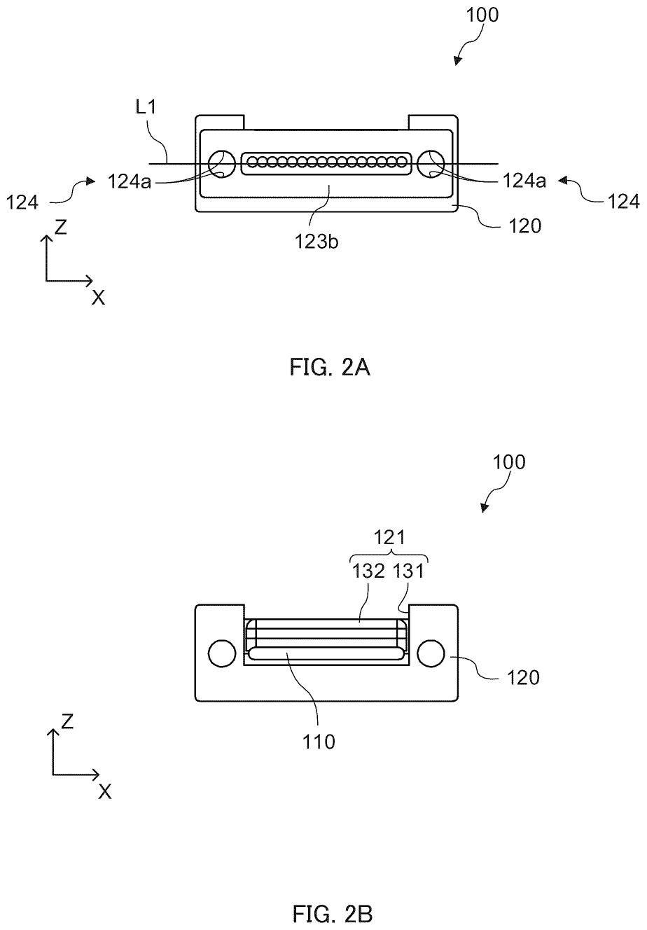

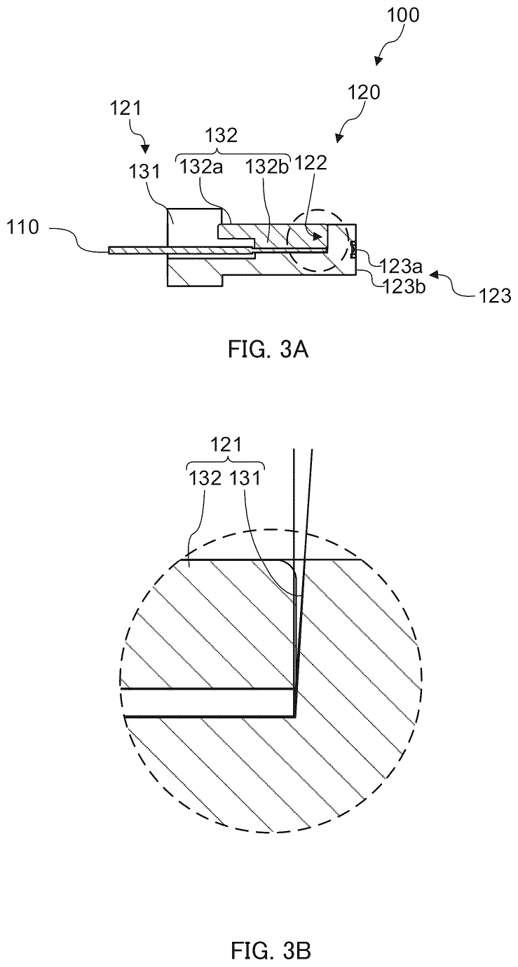

FIGS. 1A, 1B, 2A, 2B, 3A, and 3B illustrate the configuration of optical connector 100 according to Embodiment 1. FIG. 1A is a plan view of optical connector 100 according to Embodiment 1, and FIG. 1B is a bottom view of optical connector 100. FIG. 2A is a front view of optical connector 100, and FIG. 2B is a rear view of optical connector 100. FIG. 3A is a cross-sectional view taken along line A-A in FIG. 1A, and FIG. 3B is an enlarged view of a region surrounded by a broken line in FIG. 3A.

In the description below, a direction in which optical transmission bodies 110 are disposed in parallel to each other (a direction in which second surfaces 123a of second optical surface 123 are arranged) is referred to as a “first direction” or “X-direction,” the direction (height direction) perpendicular to an X-direction when second optical surface 123 is viewed from the front is referred to as a “second direction” or “Z-direction,” and a direction perpendicular to the X-direction and the Z-direction is referred to as a “third direction” or “Y-direction.” Further, in the assembly of optical connector 100, a side from which an adhesive is injected is referred to as a upper side (upper surface), and the side opposite to the upper side is referred to as a lower side (lower surface). The upper side and the lower side are not intended to mean the directions in actual use, but are defined for the purpose of description in the present embodiment.

As illustrated in FIGS. 1A, 1B, 2A, 2B, and 3A, 3B, optical connector 100 according to Embodiment 1 includes optical transmission bodies 110 and ferrule 120. Optical connector 100 according to the present embodiment can be used as an optical connector module together with components such as a housing and a spring clamp structure (not illustrated).

Optical connector 100 is used with a plurality of optical transmission bodies 110 held in its ferrule 120. Optical connector 100 is used as a set of two (used in a pair). With respect to one optical connector 100 holding a plurality of optical transmission bodies 110, another optical connector 100 having the same shape and holding another plurality of optical transmission bodies 110 is turned upside down, then optical connectors 100 are connected to each other, thereby optically coupling the plurality of optical transmission bodies with the other plurality of optical transmission bodies 110.

The type of optical transmission body 110 is not limited. Examples of optical transmission body 110 include optical fibers and optical waveguides. In the present embodiment, optical transmission body 110 is an optical fiber. The optical fiber may be a single-mode optical fiber or a multi-mode optical fiber. An end surface of optical transmission body 110 is inclined with respect to a plane that is perpendicular to an extending direction of optical transmission body 110. In other words, when viewed along a first direction (X-direction), the end surfaces of plurality of optical transmission bodies 110 are inclined with respect to a second direction (Z-direction), which is perpendicular to the first direction (X-direction). In the present embodiment, the inclination angle with respect to the second direction (Z-direction) is, for example, 8°. The orientation in which the end surface of optical transmission body 110 is inclined is not limited. For example, the end surface of optical transmission body 110 may be inclined toward second surface 123a as the end surface approaches the upper surface of ferrule 120, or may be inclined toward second surface 123a as the end surface approaches the lower surface of ferrule 120. The number of optical transmission bodies 110 is not limited as long as the number is more than one. In the present embodiment, the number of optical transmission bodies 110 is 16. The end portion of optical transmission body 110 is fixed to ferrule 120.

### Configuration of Ferrule

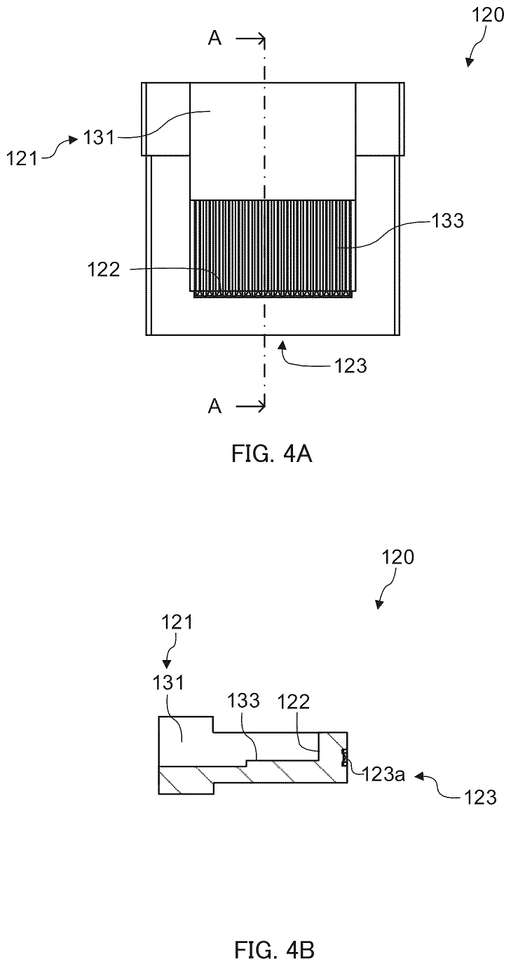

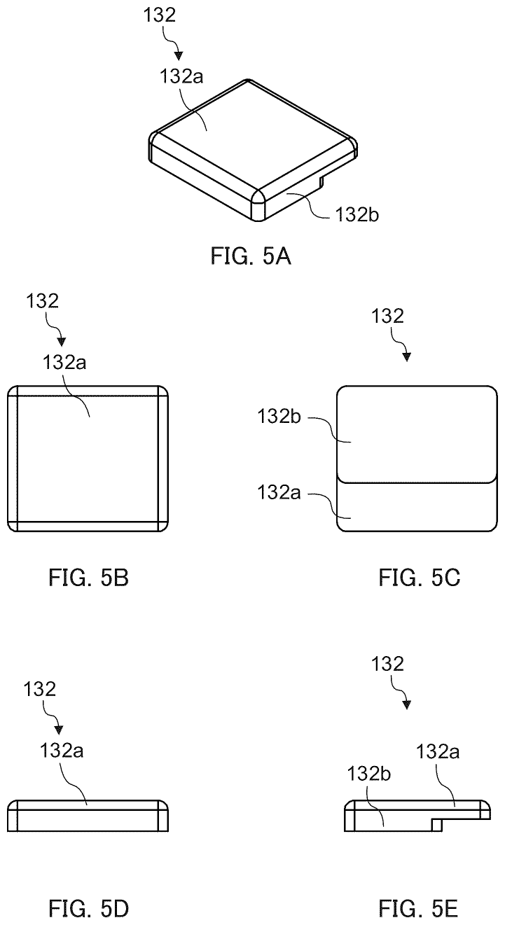

FIG. 4A is a plan view of ferrule 120 excluding the lid, and FIG. 4B is a cross-sectional view taken along line A-A illustrated in FIG. 4A. FIG. 5A is a perspective view, FIG. 5B is a plan view, FIG. 5C is a bottom view, FIG. 5D is a front view, and FIG. 5E is a right side view each illustrating lid 132.

As illustrated in FIGS. 2A, 2B, 4A, and 4B, and FIG. 5A to 5E, ferrule 120 has a substantially rectangular parallelepiped shape. Ferrule 120 includes holding section 121, first surface 122, second optical surface 123, and at least one pair of movement prevention sections 124.

Ferrule 120 is formed of a material that allows light having a wavelength used in optical communication to pass therethrough. Examples of the material of ferrule 120 include a transparent resin such as polyetherimide (PEI) such as ULTEM (trade mark), polycarbonate (PC), a cycloolefin polymer (COP), polyethersulfone (PES), and polysulfone (PSU). Ferrule 120 may be produced by injection molding, for example.

Holding section 121 holds the end portions of a plurality of optical transmission bodies 110. The configuration of holding section 121 is not limited as long as the end portions of the plurality of optical transmission bodies 110 can be held in appropriate positions. Holding section 121 may be configured to press to hold the end portions of optical transmission bodies 110 or may be configured to allow thereto insertion of the end portions of optical transmission bodies 110 to hold the optical transmission bodies. In the present embodiment, holding section 121 presses to hold the end portions of optical transmission bodies 110. In the present embodiment, holding section 121 includes holding recess section 131 and lid 132.

Holding recess section 131 opens to the upper surface and the rear surface of ferrule 120. The planar shape of holding recess section 131 is not limited as long as the end portions of a plurality of optical transmission bodies 110 can be disposed at appropriate positions. In the present embodiment, holding recess section 131 has a rectangular shape in plan view.

A plurality of grooves 133 defined by a plurality of protrusions are disposed on a bottom surface of holding recess section 131. The disposition of the plurality of grooves 133 is not limited as long as the end portions of the plurality of optical transmission bodies 110 can be appropriately positioned. The plurality of grooves 133 may be disposed over the entire bottom surface of holding recess section 131 or may be disposed in a part of the bottom surface of holding recess section 131. In the present embodiment, grooves 133 are disposed in a region in a part of the bottom surface of holding recess section 131 on the first surface 122 side.

The number of grooves 133 may be any number equal to or larger than the number of optical transmission bodies 110 to be installed. In the present embodiment, the number of grooves 133 is 16. Groove 133 may be a V-shaped groove or a U-shaped groove. Here, the “V-groove” refers to a groove constituted by two flat surfaces, and has a V-shaped cross section perpendicular to an extending direction of the groove. The connecting section of the two flat surfaces may have another flat surface between the two flat surfaces, or the connecting section between adjacent grooves 133 may be connected with a curved surface. The “U-groove” is a groove constituted by one curved surface, and has an arc-shaped cross section perpendicular to the extending direction of the groove. In the present embodiment, groove 133 is a V-shaped groove. A depth of groove 133 is preferably such that, in a state where optical transmission body 110 is disposed at groove 133, the upper end portion of optical transmission body 110 is positioned above the upper end portion of groove 133 (protrusion). This configuration allows optical transmission body 110 to be pressed against groove 133 by lid 132 described below, preventing optical transmission body 110 from coming off.

Groove 133 may be disposed parallel to the back surface of ferrule 120, or may be disposed such that groove 133 approaches the back surface of ferrule 120 as groove 133 approaches first surface 122. In the present embodiment, groove 133 is disposed parallel to the back surface of ferrule 120.

Lid 132 pushes a plurality of optical transmission bodies 110 toward grooves 133. In other words, lid 132 presses the plurality of optical transmission bodies 110 toward an optical connector main body including holding recess section 131, first surface 122, and second optical surface 123. Lid 132 is disposed so as to cover holding recess section 131, in which the end portions of optical transmission bodies 110 are disposed. Lid 132 may have any configuration as long as the lid can exhibit the above function. In the present embodiment, lid 132 includes lid main body 132a and protruding section 132b. Lid main body 132a covers holding recess section 131 from the front surface side of ferrule 120. Protruding section 132b protrudes toward the back surface side of lid main body 132a.

In the present embodiment, the end portions of the plurality of optical transmission bodies 110 are respectively disposed on the plurality of grooves 133, and the end surfaces of the plurality of optical transmission bodies 110 are brought into contact with the first surface 122. In this state, between the end surface of optical transmission body 110 and first surface 122, an adhesive is applied so that no air layer remains. Before the adhesive is cured, lid 132 pushes the end portions of the plurality of optical transmission bodies 110 toward the bottom surface (connector main body) of holding recess section 131. In this state, by curing the adhesive, optical transmission bodies 110 can be fixed to ferrule 120. The adhesive may be a thermosetting resin or a photocurable resin.

First surface 122 is disposed to face the end surfaces of the plurality of optical transmission bodies 110 held by holding section 121. First surface 122 allows thereon incidence of light emitted from the plurality of optical transmission bodies 110, or allows therefrom emission of light incident on second surfaces 123a toward end surfaces of the plurality of optical transmission bodies 110. First surface 122 may have any shape as long as the first surface can exhibit the above functions. First surface 122 may include a plurality of protruding surfaces or may be a flat surface. In the present embodiment, first surface 122 is a flat surface. First surface 122 is disposed on a part of the inner surface of holding recess section 131.

A surface (with which the end surfaces of optical transmission bodies 110 come into contact) of first surface 122 may be inclined such that the surface approaches second surface 123a as the surface approaches the back surface of ferrule 120, or may be perpendicular to the back surface of ferrule 120. In the present embodiment, the surface (with which the end surfaces of optical transmission bodies 110 come into contact) of first surface 122 is inclined such that the surface approaches second surface 123a as the surface approaches the back surface of ferrule 120 (see FIG. 3B). An inclination angle of first surface 122 is preferably the same as the inclination angle of the end surface of optical transmission body 110. The inclination angle of first surface 122 is, for example, 3 to 8°, and is preferably 5 to 8° when the second direction (Z-direction) is 0°. In the present embodiment, the inclination angle of first surface 122 is 8° when the second direction (Z-direction) is 0°.

In the present embodiment, second surface 123a is a part of second optical surface 123. Second optical surface 123 emits the light incident on first surface 122, or allows thereon incidence of light from another ferrule 120. The shape of second optical surface 123 is not limited as long as the shape can exhibit the function described above. Second optical surface 123 may include a plurality of protruding surfaces or may be a flat surface. In the present embodiment, second optical surface 123 includes a plurality of second surfaces 123a that are protruding surfaces. Second surface 123a are disposed in parallel to each other in the first direction (X-direction), and allow therefrom emission of light incident on first surface 122 toward another ferrule 120 or allow thereon incidence of light from another ferrule 120. Second surfaces 123a are disposed on a front surface of ferrule 120. The planar shape of second surface 123a is not limited. The planar shape of second surface 123a may be circular or rectangular. In the present embodiment, the planar shape of second surface 123a is circular. Further, the number of second surfaces 123a is the same as the number of optical transmission bodies 110. That is, the number of second surfaces 123a is 16 in the present embodiment.

At least one pair of movement prevention sections 124 are disposed in positions in such a way that each movement prevention section is linearly symmetrical with respect to first reference straight line L1 that is parallel to the first direction (X-direction) when the movement prevention section is viewed along the optical path between optical connector 100 and another optical connector 100. In other words, in a plane that is perpendicular to the extending direction of optical transmission body 110 and includes first reference straight line L1, the at least one pair of movement prevention sections 124 are disposed in positions in such a way that each movement prevention section is linearly symmetrical with respect to first reference straight line L1. The at least one pair of movement prevention sections 124 are fitted to another optical connector 100 directly or via other members, and restrict the movement of optical connector 100 with respect to the other optical connector 100 in the second direction (Z-direction), which is perpendicular to the first direction (X-direction). The at least one pair of movement prevention sections 124 each include movement prevention surface 124a that contributes to the movement prevention in the second direction (Z-direction). The configurations of the at least one pair of movement prevention sections 124 and movement prevention surfaces 124a are not limited as long as the above-described function can be exhibited. Examples of the at least one pair of movement prevention sections 124 in a case where optical connector 100 is directly fitted with another optical connector 100 include recess sections and protrusion sections. The recess section and the protrusion section may be provided in at least one pair (one set), or may be provided in two pairs (two sets) or more. In this case, movement prevention surfaces 124a are a part of the inner surface of the recess section and a part of the outer peripheral surface of the protrusion section. An example of the at least one pair of movement prevention sections 124 in a case where optical connector 100 is fitted with another optical connector 100 via other members includes a pair of recess sections into which the other members are inserted. The pair of recess sections may be at least one pair (one set), and may be two pairs (two sets) or more. In this case, each of movement prevention surface 124a is a part of the inner surface of the recess section. In the present embodiment, the at least one pair of movement prevention sections 124 are disposed at both end portions in the first direction, and are each a fitting hole into which a fitting pin (not illustrated) is inserted. Further, movement prevention surfaces 124a are an inner surface of the upper half of the inner surface of a fitting hole and an inner surface of the lower half of the inner surface of the fitting hole.

In the front surface of ferrule 120, a region of contact surface 123b in which second surfaces 123a and the fitting holes are not disposed is a flat surface in the present embodiment. Contact surface 123b comes into contact with contact surface 123b of another ferrule 120. Contact surface 123b may be disposed so as to be perpendicular to the back surface of ferrule 120 or may be disposed so as to be inclined with respect to the back surface of ferrule 120. In the present embodiment, contact surface 123b is disposed so as to be perpendicular to the back surface of ferrule 120.

Here, a relationship between second surface 123a, optical transmission body 110, and movement prevention section 124 will be described. Generally, ferrule 120 that holds optical transmission bodies 110 is slightly deformed according to the use environment (temperature). When ferrule 120 is deformed due to the use environment, the optical coupling efficiency decreases. Accordingly, in the present invention, optical connector 100 capable of preventing a decrease in the optical coupling efficiency even when the usage environment changes has been found. Specifically, in the present embodiment, it has been found that it is possible to suppress a decrease in the optical coupling efficiency caused by deformation of ferrule 120 in the second direction (Z-direction).

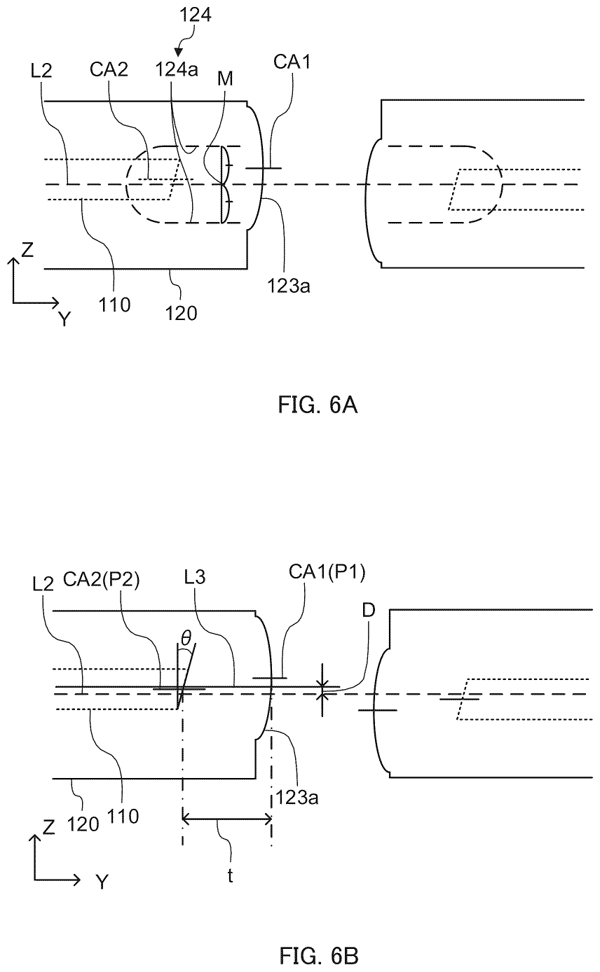

FIGS. 6A and 6B are diagrams for describing the relationship between second surface 123a, optical transmission body 110, and movement prevention section 124.

In a cross section along the second direction (Z-direction) and including a first central axis CA1 of any one of the plurality of second surfaces 123a and a second center axis CA2 of optical transmission body 110 (corresponding to the one second surface 123a) of the plurality of optical transmission bodies 110, the first center axis CA1 and the second center axis CA2 are positioned closer to a tip end of the optical transmission body 110 than a fitting centerline (the second reference straight line L2) of at least a pair of movement prevention sections 124 is. Here, optical transmission body 110 corresponding to second surface 123a means optical transmission body 110 (among the plurality of optical transmission bodies 110) which emits or allows incidence thereon light that passes through the target second surface 123a. Further, the fitting centerline of at least one pair of movement prevention sections 124 means second reference straight line L2 that passes through the midpoint of movement prevention surfaces 124a in the second direction (Z-direction) and is along the third direction (Y-direction) perpendicular to the first direction (X-direction) and the second direction (Z-direction) in the cross section. Further, the tip end of optical transmission body 110 means a part (corner) at which an angle between the end surface of optical transmission body 110 and the side surface of optical transmission body 110 is an acute angle in the cross section. As described above, the end surface of optical transmission body 110 is inclined with respect to the second direction (Z-direction) perpendicular to the first direction (X-direction). In FIGS. 6A and 6B, the tip end of optical transmission body 110 on the left side in the drawings is positioned at the upper end of the end surface of optical transmission body 110.

Here, the second reference straight line (fitting centerline) L2 will be described specifically. The second reference straight line L2 corresponds to a fitting center (reference position for fitting) defined by the fitting structure of at least one pair of movement prevention sections 124. In two optical connectors 100 connected to each other, second reference straight line (fitting centerline) L2 of one ferrule 120 and second reference straight line (fitting centerline) L2 of the other ferrule 120 coincide with each other. As illustrated in FIG. 6A, second reference straight line L2 is set based on at least one pair of movement prevention sections 124. As described above, in the present embodiment, the pair of movement prevention sections 124 are fitting holes, and movement prevention surfaces 124a are the inner surface of an upper half of a fitting hole and the inner surface of a lower half of the fitting hole. Further, a straight line passing through midpoint M between upward and downward movement prevention surfaces 124a in the second direction (Z-direction) and along the third direction (Y-direction) is defined as second reference straight line L2. In the present embodiment, the fitting hole is disposed such that a center axis thereof superpose midpoint M in the second direction (Z-direction).

Next, third reference straight line L3 will be described. First, an assumption is made as follows: optical connector 100 and another optical connector 100 are engaged with each other via at least one pair of movement prevention section 124, and first center axis CA1 and second center axis CA2 are positioned on the same straight line. Under this assumption, third reference straight line L3 is defined as a straight line positioned on first center axis CA1 and second center axis CA2 at a time when the optical coupling efficiency between the plurality of optical transmission bodies 110 and the other plurality of optical transmission bodies 110 is maximized. The third reference straight line L3 is parallel to the second reference straight line L2. In the present embodiment, the end surface of optical transmission body 110 is inclined, and thus, second reference straight line L2 and third reference straight line L3 do not coincide with each other. Third reference straight line L3 can be determined from each parameter of optical connector 100 with reference to second reference straight line L2.

### Experiment

In the following, the influence of the optical coupling efficiency was examined in response to a change in the use environment of optical connector 100. As an optical connector, optical connector 100 of the present embodiment, an optical connector of Comparative Example 1, and an optical connector of Comparative Example 2 were used. In this simulation, 25° C. and 85° C. were investigated as the use temperatures.

A common condition between optical connector 100 of the present embodiment and an optical connector of a comparative example is as follows. The distance t between the vertex of second surface 123a and the center of optical transmission body 110 in the third direction (Y-direction) of the YZ cross section was set to 1.0 mm. The inclination angle θ of the end surface of optical transmission body 110 was set to 8°. The distance between the two second surfaces 123a was set to 0.2 mm. The distance between the second reference straight line L2 and the third reference straight line L3 was set to 0.01392 mm. The wavelength of the light emitted from optical transmission body 110 was set to 1310 nm. The tip end of optical transmission body 110 is positioned on the upper side in FIGS. 6A and 6B. The material of optical connector 100 was polyethyleneimine. The refractive index of polyethyleneimine is 1.62.

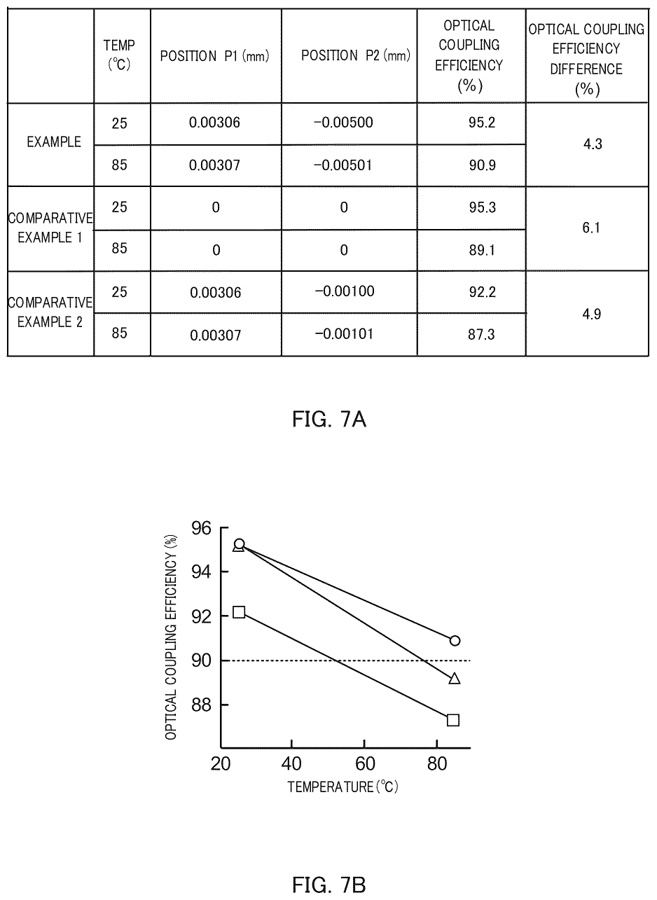

FIG. 7A is a table illustrating the analysis results, and FIG. 7B is a graph plotted for the optical coupling efficiency in FIG. 7A. In FIG. 7A, the position P1 of the vertex of second surface 123a with respect to third reference straight line L3 and the position P2 of the center of optical transmission body 120 with respect to the vertex of second surface 123a are represented by positive numbers when the target is above the reference, and are indicated by negative values when the target is below the reference. The horizontal axis in FIG. 7B represents the use temperature (the temperature of ferrule 120), and the vertical axis represents the optical coupling efficiency. In the present implementation, the minimum acceptable value for the optical coupling efficiency was set to 90%. The round symbols illustrated in FIG. 7B represent the results of optical connector 100 in the present embodiment, the triangular symbols represent the results of the optical connector in Comparative Example 1, and the square symbols represent the results of the optical connector in Comparative Example 2.

As is clear from the above-described conditions and the table in FIG. 7A, in all the cases of optical connector 100 in Example, the optical connector in Comparative Example 1, and the optical connector in Comparative Example 2, the first center axis CA1 and the second center axis CA2 are all positioned on the tip end side of optical transmission body 110 with respect to second reference straight line L2.

Further, the table in FIG. 7A indicates that third reference straight line L3 is positioned between first center axis CA1 and second center axis CA2 in optical connector 100 of Example. In contrast, it is indicated that third reference straight line L3 in the optical connector of Comparative Example 1 coincides with first center axis CA1 and second center axis CA2. Further, it is indicated that third reference straight line L3 is positioned on the bottom surface side of the optical connector with respect to first center axis CA1 and second center axis CA2 in Comparative Example 2.

As illustrated in FIGS. 7A and 7B, it can be seen that optical connector 100 in Example can prevent a decrease in the optical coupling efficiency even when the use environment changes, and can maintain the optical coupling efficiency in the acceptable range. This is considered to be because, in optical connector 100 in Example, the irradiation spot of the light emitted from optical connector 100 continues to be positioned on an end surface of optical transmission body 110 in another optical connector 100 even when the usage environment changes.

On the other hand, the optical connectors of Comparative Examples 1 and 2 exhibited a high optical coupling efficiency when the use environment was 25° C., whereas the optical coupling efficiency was remarkably decreased when the use environment was 85° C. This is considered to be because, in the optical connectors of Comparative Examples 1 and 2, a part of the irradiation spot of the light emitted from the optical connector has moved away from the end surface of optical transmission body 110 in another optical connector due to a change in the usage environment.

### Using Method of Optical Connector

Here, a using method of optical connector 100 will be described. Fitting pins (not illustrated) are inserted into respective fitting holes (movement prevention sections 124) of one ferrule 120. Subsequently, the one ferrule 120 is positioned with its lid 132 facing upward, and the other ferrule 120 is positioned such that optical connector 100 is rotated (turned upside down) with first reference straight line L1 as the rotation axis. The fitting pin inserted into the fitting hole of the one optical connector 100 is fitted into the fitting hole of the other optical connector 100. Thus, the plurality of optical transmission bodies 110 connected to the one optical connector 100 are optically connected to optical transmission bodies 110 connected to the other optical connector 100.

### Effect

According to the present invention, first center axis CA1 of second surface 123a and second center axis CA2 of optical transmission body 110 are positioned closer to the tip end of optical transmission body 110 than second reference straight line L2 is, and third reference straight line L3 is disposed between first center axis CA1 and second center axis CA2. Therefore, the decrease in the optical coupling efficiency can be suppressed regardless of the use environment (temperature).

### Embodiment 2

In the following, optical connector 200 according to Embodiment 2 will be described. Optical connector 200 according to the present embodiment differs from optical connector 100 according to Embodiment 1 only in the configuration of ferrule 220. Therefore, the same components as those of optical connector 100 according to Embodiment 1 are designated by the same reference numerals and the description thereof will be omitted.

### Configuration of Optical Connector

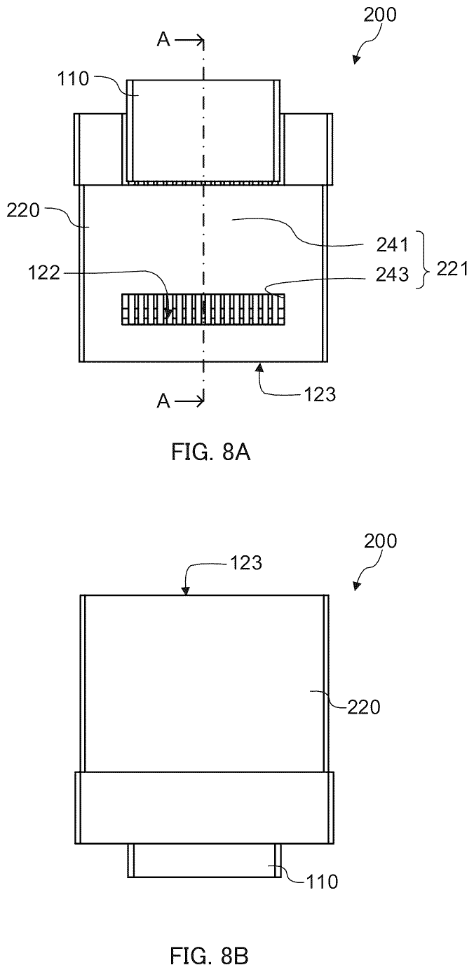

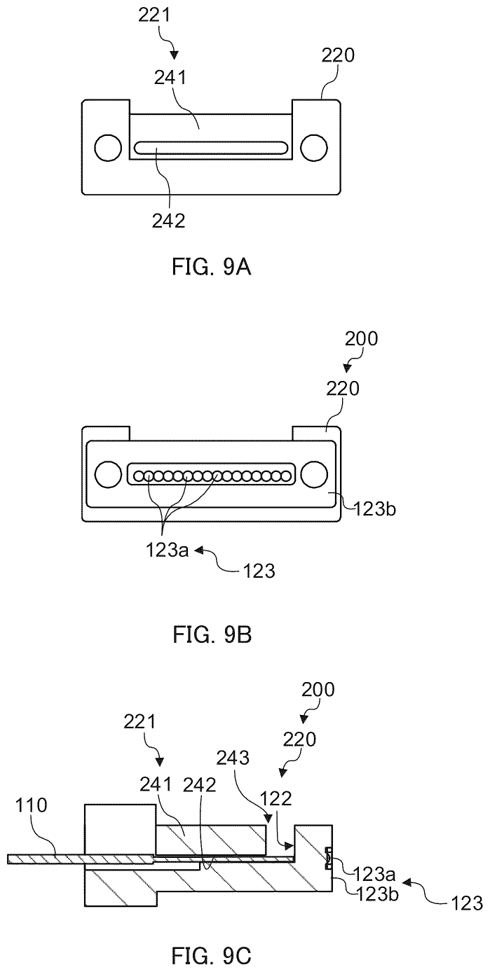

FIGS. 8A and 8B and FIGS. 9A to 9C illustrate the configuration of optical connector 200 according to Embodiment 2. FIG. 8A is a plan view and FIG. 8B is a bottom view each illustrating optical connector 200 according to Embodiment 2. FIG. 9A is a front view, FIG. 9B is a rear view, and FIG. 9C is a cross-sectional view taken along line A-A in FIG. 8A each illustrating optical connector 200.

As illustrated in FIGS. 8A and 8B and 9A to 9C, optical connector 200 according to the present embodiment includes optical transmission bodies 110 and ferrule 220. Optical connector 200 according to the present embodiment can be used as an optical connector module together with components such as a housing and a spring clamp structure (not illustrated). In the present embodiment, the end surface of optical transmission body 110 is also inclined with respect to the second direction (Z-direction).

Ferrule 220 according to the present embodiment includes holding section 221, first surface 122, second optical surface 123, and at least one pair of movement prevention sections 124. Ferrule 220 according to the present embodiment is configured such that optical transmission bodies 110 are inserted thereto and ferrule 220 hold the end portions of optical transmission bodies 110.

In the present embodiment as well, at least one pair of movement prevention sections 124 are disposed in positions in such a way that each movement prevention section is linearly symmetrical with respect to first reference straight line L1 that is parallel to the first direction (X-direction) when the movement prevention section is viewed along the optical path between optical connector 200 and another optical connector 200. In addition, the at least one pair of movement prevention sections 124 are fitted to another optical connector 200 via other members. In other words, in a plane that is perpendicular to the extending direction of optical transmission body 110 and includes first reference straight line L1, the at least one pair of movement prevention sections 124 are disposed in positions in such a way that each movement prevention section is linearly symmetrical with respect to first reference straight line L1. The at least one pair of movement prevention surfaces 125 each contribute to the movement prevention in the second direction (Z-direction). Further, first center axis CA1 and second center axis CA2 are positioned closer to the tip end of optical transmission body 110 than second reference straight line L2 is. Further, third reference straight line L3 is positioned between first center axis CA1 and second center axis CA2.

Holding section 221 holds optical transmission bodies 110. In the present embodiment, holding section 221 includes insertion section 241, a plurality of through-holes 242, and recess section 243 for an adhesive (herein referred to as “adhesive recess section 243”).

Insertion section 241 is a section in which the plurality of through-holes 242 into which a plurality of optical transmission bodies 110 are inserted are formed. Insertion section 241 is a wall disposed between adhesive recess section 243 and the recess section that opens to the rear surface of ferrule 220. The plurality of through-holes 242 are formed in a bottom section of insertion section 241. The plurality of through-holes 242 are disposed such that optical transmission bodies 110 are parallel to the back surface of optical connector 200.

The plurality of through-holes 242 are configured such that the plurality of optical transmission bodies 110 are disposed at predetermined intervals. The size of through-hole 242 may be any size as long as optical transmission body 110 can be inserted therein. One side of through-hole 242 opens to adhesive recess section 243, and the other side opens to the recess section.

Adhesive recess section 243 is filled with an adhesive injected therein to fix optical transmission bodies 110 to first surface 122. A part of the inner surface of adhesive recess section 243 is first surface 122. Further, through-hole 242 opens on the inner surface facing first surface 122.

### Assembling Method and Using Method for Optical Connector

In optical connector 200 according to the present embodiment, an end portion of each optical transmission body 110 is inserted into through-hole 242, and the end surface of each optical transmission body 110 is brought into contact with first surface 122. Next, an adhesive is injected into adhesive recess section 243 and cured, thereby fixing optical transmission bodies 110 to optical connector 200. Finally, with respect to one optical connector 200 to which a fitting pin is attached, the other optical connector 200 is turned upside down to join optical connectors 200 to each other. Thus, optical transmission bodies 110 are optically coupled to each other.

### Effect

Optical connector 200 according to Embodiment 2 has the same effect as that in Embodiment 1. Further, the optical connector according to Embodiment 2 does not include lid 132, and thus, it is possible to reduce the cost by further reducing the number of components.

### Embodiment 3

In the following, optical connector 300 according to Embodiment 3 will be described. Optical connector 300 according to the present embodiment differs from optical connector 100 according to Embodiment 1 only in the configuration of ferrule 320. Therefore, the same components as those of optical connector 100 according to Embodiment 1 are designated by the same reference numerals and the description thereof will be omitted.

### Configuration of Optical Connector

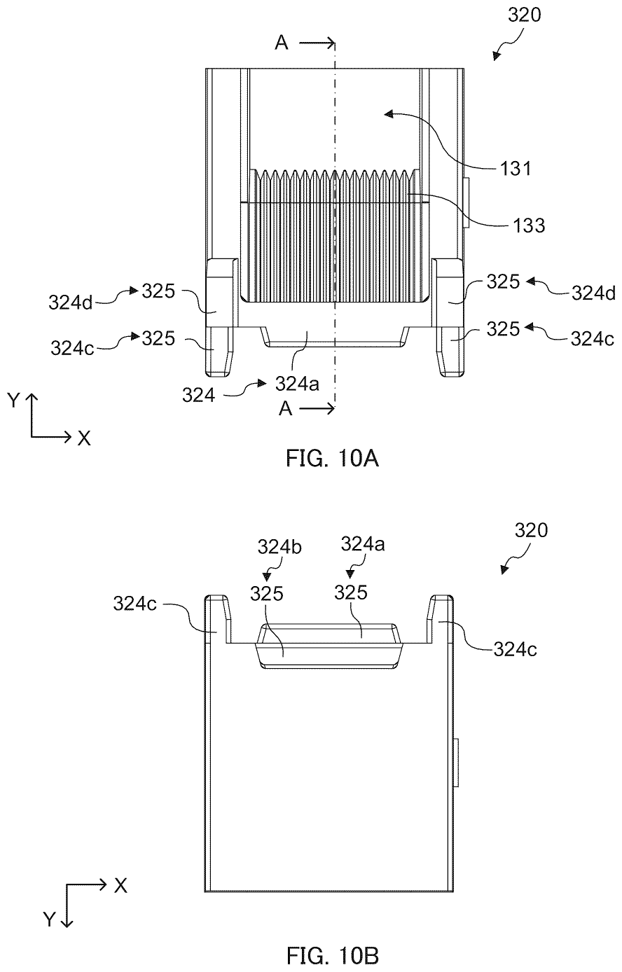

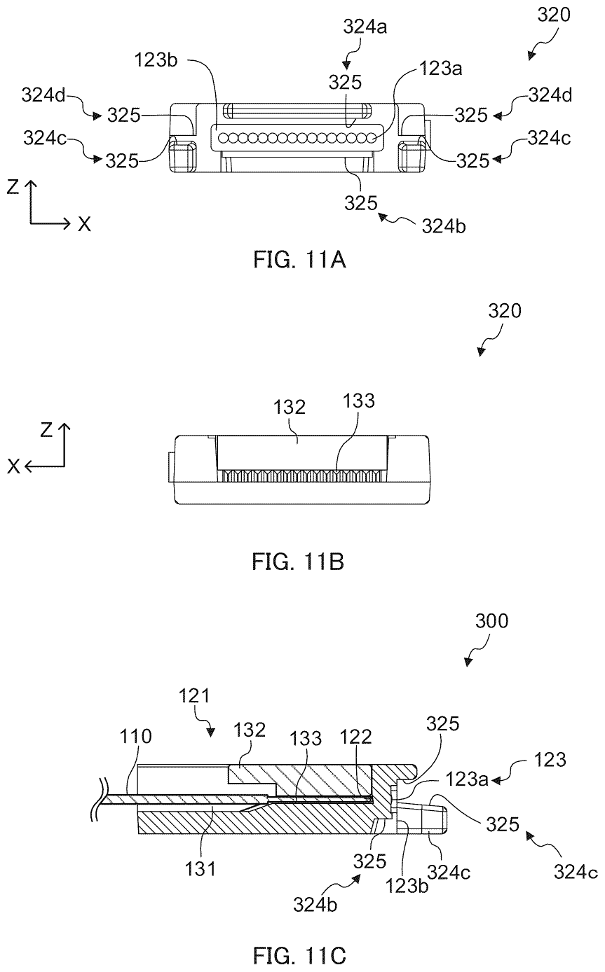

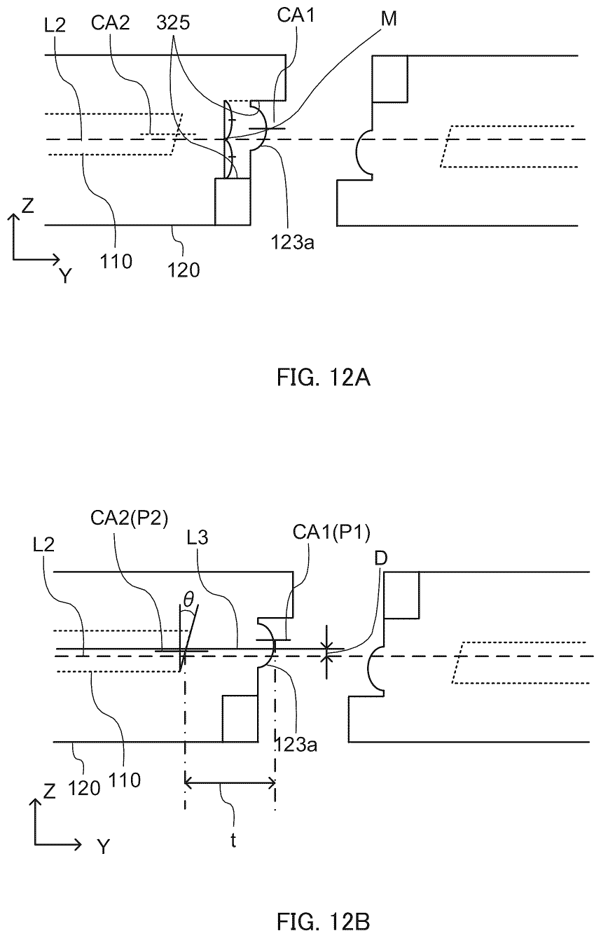

FIGS. 10A and 10B and FIGS. 11A to 11C illustrate the configuration of optical connector 300 according to Embodiment 3. FIG. 10A is a plan view and FIG. 10B is a bottom view each illustrating optical connector 300 according to Embodiment 3. FIG. 11A is a front view, FIG. 11B is a rear view, and FIG. 11C is a cross-sectional view of line A-A in FIG. 10A each illustrating optical connector 300. In FIGS. 10A and 10B, lid 132 and optical transmission body 110 are omitted. In FIG. 11B, optical transmission body 110 is omitted. FIGS. 12A and 12B are diagrams for describing the relationship between second surface 123a, optical transmission body 110, and movement prevention section 324.

As illustrated in FIGS. 10A and 10B and FIGS. 11A to 11C, optical connector 300 according to the present embodiment includes optical transmission bodies 110 and ferrule 320. Optical connector 300 according to the present embodiment can be used as an optical connector module together with components such as a housing and a spring clamp structure (not illustrated). In the present embodiment, the end surface of optical transmission body 110 is also inclined with respect to the second direction (Z-direction).

Ferrule 320 according to the present embodiment includes holding section 121, first surface 122, second optical surface 123, and at least one pair of movement prevention sections 324. Holding section 121 has a configuration in which the end portion of optical transmission body 110 is pressed and held.

The at least one pair of movement prevention sections 324 are disposed in positions in such a way that each movement prevention section is linearly symmetrical with respect to first reference straight line L1 that is parallel to the first direction (X-direction) when the movement prevention section is viewed along the optical path between optical connector 300 and another optical connector 300. The at least one pair of movement prevention sections 324 directly fit with another optical connector 300, and restrict movement with respect to the other optical connector 300 in the second direction (Z-direction), which is perpendicular to the first direction (X-direction). In other words, in a plane that is perpendicular to the extending direction of optical transmission body 110 and includes first reference straight line L1, the at least one pair of movement prevention sections 324 are disposed in positions in such a way that each movement prevention section is linearly symmetrical with respect to the first reference straight line L1. The at least one pair of movement sections 324 each contribute to the movement prevention of optical connector 300 in the second direction (Z-direction). Further, first center axis CA1 and second center axis CA2 are positioned closer to the tip end of optical transmission body 110 than second reference straight line (fitting centerline) L2 is. Further, third reference straight line L3 is positioned between first center axis CA1 and second center axis CA2. In the present embodiment, the at least one pair of movement prevention sections 324 includes one set of first protrusion section 324a and first recess section 324b, and two sets of second protrusion section 324c and second recess section 324d.

First protrusion section 324a has a shape capable of being fitted into first recess section 324b of another optical connector 300. In the present embodiment, first protrusion section 324a is disposed on the front surface (upper side) of optical connector 300. The shape of first protrusion section 324a is not limited as long as the first protrusion section can prevent a position deviation of optical connector 300 in the second direction (Z-direction). In the present embodiment, the shape of first protrusion section 324a is a protrusion wide in the first direction (X-direction). First protrusion section 324a includes movement prevention surface 325. In the present embodiment, movement prevention surface 325 is a flat surface that is disposed inward in the second direction (Z-direction).

First recess section 324b has a shape capable of being fitted with first protrusion section 324a of another optical connector 300. In the present embodiment, first recess section 324b is disposed on the back side (lower side) of optical connector 300 in the front surface. The shape of first recess section 324b is not limited as long as the first recess section can prevent the position deviation of optical connector 300 in the second direction (Z-direction). In the present embodiment, first recess section 324b is a recess section that opens to the front surface and the bottom surface of optical connector 300. First recess section 324b includes movement prevention surface 325. In the present embodiment, movement prevention surface 325 is a flat surface that is disposed outward in the second direction (Z-direction).

Second protrusion sections 324c are disposed on the back surface side at both end portions of optical connector 300 in the first direction (X-direction), and have a rectangular column shape protruding from the front surface of optical connector 300. Second protrusion section 324c includes movement prevention surface 325. In the present embodiment, movement prevention surface 325 is a flat surface that is disposed inward in the second direction (Z-direction).

Second recess sections 324d are recess sections that are located at both end portions in the first direction (X-direction), and open at the corners on the front surface (upper surface) side. Second recess section 324d includes movement prevention surface 325. In the present embodiment, movement prevention surface 325 is a flat surface that is disposed outward in the second direction (Z-direction).

In the present embodiment, optical connector 300 includes three pairs of movement prevention sections 324 and three pairs of movement prevention surfaces 325. Even in this case, since the shape of the optical connector 300 is the same as that of the other optical connector 300, the second reference straight line L2 is a midpoint between the two (i.e., pair of) movement prevention surfaces 325. In a cross section along the second direction (Z-direction) and the third direction (Y-direction), each movement prevention surface 325 may be inclined with respect to the third direction (Y-direction) or may be parallel to the third direction (Y-direction). In the present embodiment, in the cross section, each movement prevention surface 325 is parallel to the third direction. In a case where each movement prevention surface 325 is inclined with respect to the third direction (Y-direction) in the cross section, second reference straight line (fitting centerline) L2 is a line connecting the midpoint of one movement prevention surface 325 and the corresponding midpoint of the other corresponding movement prevention surface 325.

### Assembling Method and Using Method for Optical Connector

In optical connector 300 according to the present embodiment, each optical transmission body 110 is brought into contact with first surface 122 of groove 133. Subsequently, after lid 132 presses optical transmission bodies 110 into grooves 133, an adhesive is injected and cured to fix optical transmission bodies 110 to optical connector 300. Finally, with respect to one optical connector 300, the other optical connector 300 is turned upside down to join optical connectors 300 to each other. Thus, optical transmission bodies 110 are optically coupled to each other.

### Effect

Optical connector 300 according to Embodiment 3 has the same effect as that in Embodiment 1. Further, optical connector 300 according to the present embodiment can be coupled without using any other member.

### Embodiment 4

In the following, optical connector 400 according to Embodiment 4 will be described. Optical connector 400 according to the present embodiment differs from optical connector 100 according to Embodiment 1 only in the configuration of ferrule 420. Therefore, the same components as those of optical connector 100 according to Embodiment 1 are designated by the same reference numerals and the description thereof will be omitted.

### Configuration of Optical Connector

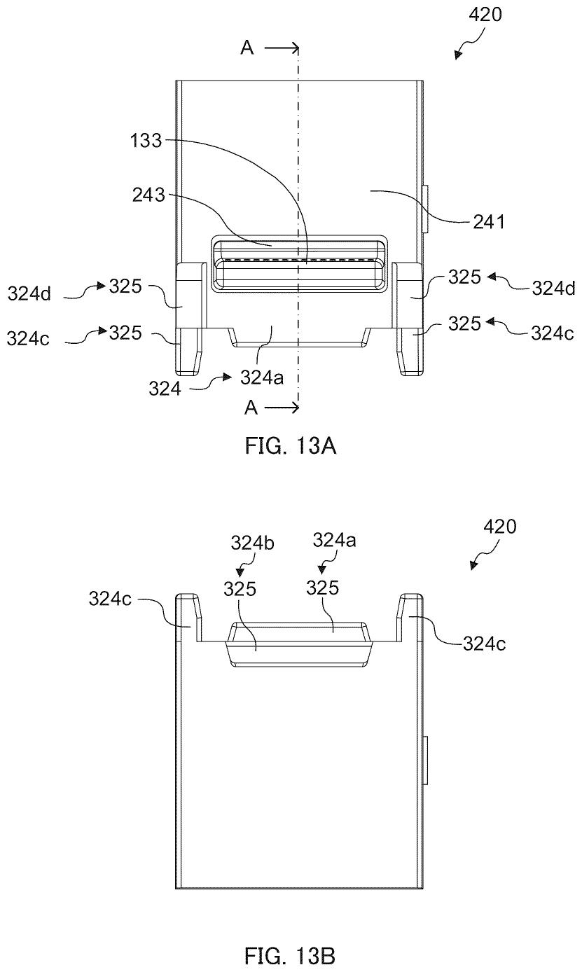

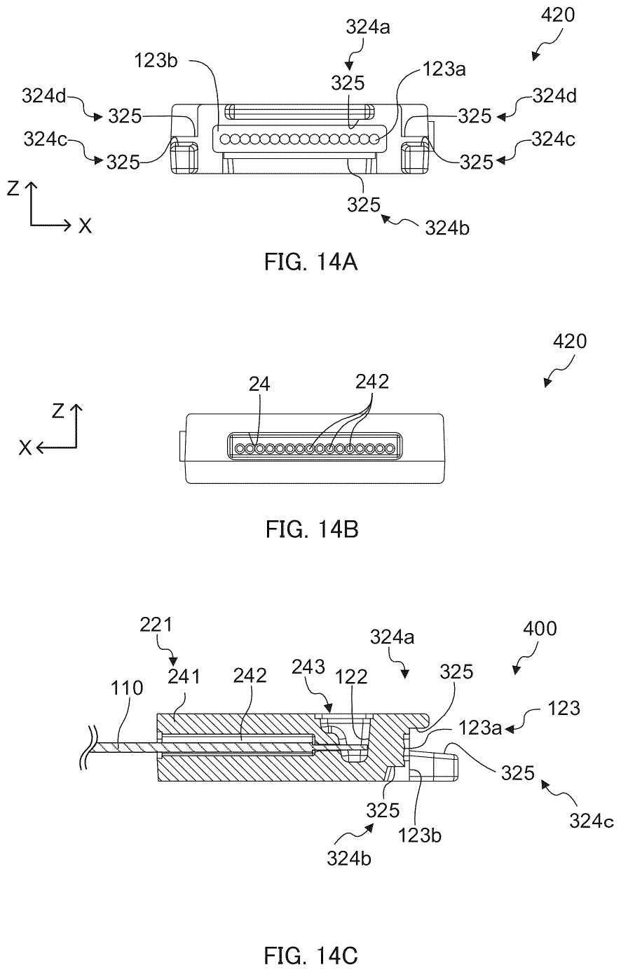

FIGS. 13A and 13B, and FIGS. 14A to 14C illustrate the configuration of optical connector 400 according to Embodiment 4. FIG. 14A is a plan view and FIG. 13B is a bottom view each illustrating optical connector 400 according to Embodiment 4. FIG. 14A is a front view, FIG. 14B is a rear view, and FIG. 14C is a cross-sectional view taken along line A-A illustrated in FIG. 13A each illustrating optical connector 400. In FIGS. 13A, 13B and 14B, optical transmission body 110 is omitted.

As illustrated in FIGS. 13A and 13B and 14A to 14C, optical connector 400 according to the present embodiment includes optical transmission bodies 110 and ferrule 420. Optical connector 400 according to the present embodiment can be used as an optical connector module together with components such as a housing and a spring clamp structure (not illustrated). In the present embodiment, the end surface of optical transmission body 110 is also inclined with respect to the second direction (Z-direction).

Ferrule 420 according to the present embodiment includes holding section 221, first surface 122, second optical surface 123, and at least one pair of movement prevention sections 324. In the present embodiment, holding section 221 configured to allow thereto insertion of the end portions of optical transmission bodies 110 to hold the optical transmission bodies.

Holding section 221 holds optical transmission body 110. In the present embodiment, holding section 221 includes insertion section 241, a plurality of through-holes 242, and adhesive recess section 243.

Insertion section 241 is a section in which a plurality of through-holes 242 into which a plurality of optical transmission bodies 110 are inserted are formed. Insertion section 241 is a wall disposed between adhesive recess section 243 and the recess section that opens to the rear surface of ferrule 220. The plurality of through-holes 242 are formed in a bottom section of insertion section 241. The plurality of through-holes 242 are disposed such that optical transmission bodies 110 are parallel to the back surface of optical connector 200.

The plurality of through-holes 242 are configured such that the plurality of optical transmission bodies 110 are disposed at predetermined intervals. The size of through-hole 242 may be any size as long as optical transmission body 110 can be inserted therein. One side of through-hole 242 opens into adhesive recess section 243, and the other side opens into the recess section.

Adhesive recess section 243 is filled with an adhesive injected therein to fix optical transmission bodies 110 to first surface 122. A part of the inner surface of adhesive recess section 243 is first surface 122. Further, through-hole 242 opens on the inner surface facing first surface 122.

The at least one pair of movement prevention sections 324 are disposed in positions in such a way that each movement prevention section is linearly symmetrical with respect to first reference straight line L1, which is parallel to the first direction (X-direction), when the movement prevention section is viewed along the optical path between optical connector 400 and another optical connector 400. The at least one pair of movement prevention sections 324 directly fits with another optical connector 400, and restrict movement with respect to another optical connector 400 in the second direction (Z-direction), which is perpendicular to the first direction (X-direction). The at least one pair of movement prevention sections 324 each contributes to the movement prevention of optical connector 400 in the second direction (Z-direction). Further, first center axis CA1 and second center axis CA2 are positioned closer to the tip end of optical transmission body 110 than second reference straight line (fitting centerline) L2 is. Further, third reference straight line L3 is positioned between first center axis CA1 and second center axis CA2. In the present embodiment, the at least one pair of movement prevention sections 324 includes one set of first protrusion section 324a and first recess section 324b, and two sets of second protrusion section 324c and second recess section 324d.

First protrusion section 324a has a shape capable of being fitted into first recess section 324b of another optical connector 300. In the present embodiment, first protrusion section 324a is disposed on the front surface (upper side) of optical connector 400. The shape of first protrusion section 324a is not limited as long as the protrusion section can prevent the position deviation of optical connector 400 in the second direction (Z-direction). In the present embodiment, the shape of first protrusion section 324a is a protrusion wide in the first direction (X-direction). First protrusion section 324a includes movement prevention surface 325. In the present embodiment, movement prevention surface 325 is a flat surface that is disposed inward in the second direction (Z-direction).

First recess section 324b has a shape capable of being fitted with first protrusion section 324a of the other optical connector 400. In the present embodiment, first recess section 324b is disposed on the back side (lower side) of optical connector 400 in the front surface. The shape of first recess section 324b is not limited as long as the first recess section can prevent the position deviation of optical connector 400 in the second direction (Z-direction). In the present embodiment, first recess section 324b is a recess section that opens to the front surface and the bottom surface of optical connector 400. First recess section 324b includes movement prevention surface 325. In the present embodiment, movement prevention surface 325 is a flat surface that is disposed outward in the second direction (Z-direction).

Second protrusion sections 324c are disposed on the back surface side at both end portions of optical connector 400 in the first direction (X-direction), and have a rectangular column shape protruding from the front surface of optical connector 400. Second protrusion section 324c includes movement prevention surface 325. In the present embodiment, movement prevention surface 325 is a flat surface that is disposed inward in the second direction (Z-direction).

Second recess sections 324d are recess sections that are located at both end portions in the first direction (X-direction), and open at the corners on the front surface (upper surface) side. Second recess section 324d includes movement prevention surface 325. In the present embodiment, movement prevention surface 325 is a flat surface that is disposed outward in the second direction (Z-direction).

In the present embodiment, optical connector 300 includes three pairs of movement prevention sections 324 and three pairs of movement prevention surfaces 325. Even in this case, since the shape of the optical connector 300 is the same as that of the other optical connector 300, the second reference straight line L2 is a midpoint between the two (i.e., pair of) movement prevention surfaces 325. In a cross section along the second direction (Z-direction) and the third direction (Y-direction), each movement prevention surface 325 may be inclined with respect to the third direction (Y-direction) or may be parallel to the third direction (Y-direction). In the present embodiment, in the cross section, each movement prevention surface 325 is parallel to the third direction. In a case where each movement prevention surface 325 is inclined with respect to the third direction (Y-direction) in the cross section, second reference straight line (fitting centerline) L2 is a line connecting the midpoint between any point of one movement prevention surface 325 and a corresponding point of the other corresponding movement prevention surface 325.

### Assembling Method and Using Method for Optical Connector

In optical connector 400 according to the present embodiment, an end portion of each optical transmission body 110 is inserted into through-hole 242, and the end surface of each optical transmission body 110 is brought into contact with first surface 122. Next, an adhesive is injected into adhesive recess section 243 and cured, thereby fixing optical transmission bodies 110 to optical connector 400. Finally, with respect to one optical connector 400, the other optical connector 400 is turned upside down to join optical connectors 400 to each other. Thus, optical transmission bodies 110 are optically coupled to each other.

### Effect

Optical connector 400 according to the present embodiment has the same effect as that in Embodiment 1. Further, optical connector 400 according to the present embodiment can be coupled without using any other member.

### Embodiment 5

In the following, optical connector 500 according to Embodiment 5 will be described. An optical connector according to Embodiment 5 optically couples a ferrule according to any one of Embodiments 1 to 4 holding a plurality of optical transmission bodies 110 (which are optical fibers) and ferrule 500 holding a plurality of optical transmission bodies 210 (which are optical waveguides), thereby optically coupling the plurality of optical transmission bodies 110 with the and other plurality of optical transmission bodies 210. Here, an example using ferrule 320 according to Embodiment 3 as a ferrule holding a plurality of optical transmission bodies 110 (which are optical fibers) will be described. Ferrule 320 is the same as that in Embodiment 3, and thus, the description thereof will be omitted.

### Configuration of Optical Connector

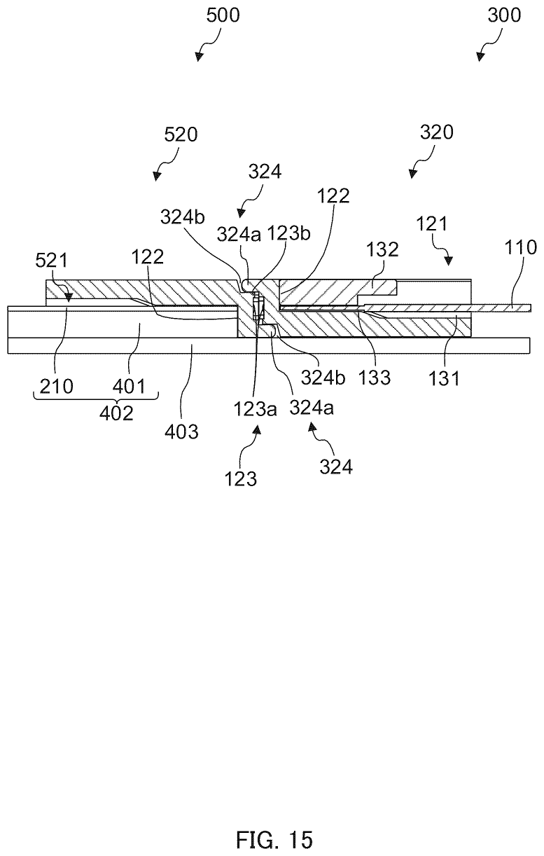

FIG. 15 is a diagram for describing a method for using optical connector 500 according to Embodiment 5 of the present invention.

As illustrated in FIG. 15, optical connector 500 according to Embodiment 5 includes substrate 403, optical transmission bodies 210, and ferrule 520.

In the present embodiment, optical transmission body 210 is an optical waveguide. Optical transmission bodies 210 are disposed on silicon substrate 401. Optical transmission bodies 210 (namely, optical waveguides) and silicon substrate 401 constitute optical circuit (photonic integrated circuit: PIC) 402. Although the position of optical transmission body 210 is not limited, optical transmission body 210 may be disposed so as to protrude upward from the recess section formed in the upper surface of optical circuit 402, or may be embedded inside optical circuit 402. Further, in the present embodiment, optical transmission body 210 includes a clad and a plurality of cores.

Ferrule 520 includes holding section 521, first surface 122, second optical surface 123, and at least one pair of movement prevention sections 324. One set of first protrusion section 324a and first recess section 324b and two sets of second protrusion section 324c and second recess section 324d in movement prevention section 324 are the same as in ferrule 320 in Embodiment 3, and therefore the description thereof will be omitted.

Holding section (disposition section) 521 holds optical transmission bodies 210 (optical waveguides). The configuration of holding section 521 is not limited as long as holding section 521 can hold optical transmission bodies 210. In the present embodiment, holding section 521 is an entire region on the rear surface side of ferrule 520 compared to first surface 122. Further, holding section (disposition section) 521 does not include groove 133 in order to dispose optical transmission bodies 210 which are optical waveguides.

### Using Method for Optical Connector

Here, a method for using optical connectors 300 and 500 will be described.

As illustrated in FIG. 15, one of the optical connectors (the one optical connector 500) in a state of being turned upside down is connected to the other one of the optical connectors (the other optical connector 300). At this time, first protrusion section 324a of the other optical connector 300 and first recess section 324b of one optical connector 500 are engaged with each other, and first recess section 324b of the other optical connector 300 and first protrusion section 324a of the one optical connector 500 are engaged with each other. Thus, the position deviation between the other optical connector 300 and the one optical connector 500 in the second direction (Z-direction) is restricted. Further, the second protrusion section 324c of the other optical connector 300 (see FIG. 11) and the second recess section 324d of the one optical connector 500 are engaged with each other, and the second recess section 324d of the other optical connector 300 (see FIG. 11) and the second protrusion section 324c of the one optical connector 500 are engaged with each other. Thus, the position deviation between the other optical connector 300 and the one optical connector 500 in the first direction (X-direction) is restricted. Further, contact surface 123a of the one optical connector 500 and contact surface 123a of other optical connector 300 are brought into contact with each other. Thus, a plurality of optical transmission bodies 110 connected to the other optical connector 300 are optically connected to optical transmission bodies 210 connected to the one optical connector 500.

### Effect

The optical connector 500 in the present embodiment has the same effects as those of the optical connector 100 according to Embodiment 1.

In the present embodiment, optical connector 300 according to Embodiment 3 has been described as an example, but even when optical connectors 100, 200, and 400 according to Embodiments 1, 2, and 4 is used, optical connector can be optically coupled to optical circuit 402 in the same manner (illustration is omitted).

The present application claims priority from Japanese Patent Application No. 2022-059175, filed on Mar. 31, 2022, the disclosure of which including the specification and drawings is incorporated by reference in its entirety.

### Industrial Applicability

The optical connector, the ferrule, and the optical connector module according to the present invention are useful for optical communication using an optical transmission body.

### REFERENCE SIGNS LIST

100, 200, 300, 400, 500 Optical connector
110, 210 Optical transmission body
120, 220, 320, 420, 520 Ferrule
121, 221, 521 Holding section
122 First surface
123 Second optical surface
123a Second surface
123b Contact surface
124, 324 Movement prevention section
125, 325 Movement prevention surface
131 Holding recess section
132 Lid
132a Lid main body
132b Protruding section
241 Insertion section
242 Through-hole
243 Adhesive recess section
324a First protrusion section
324b First recess section
324c Second protrusion section
324d Second recess section
CA1 First center axis
CA2 Second center axis
L1 First reference straight line
L2 Second reference straight line (fitting centerline)
L3 Third reference straight line

1. An optical connector that holds a plurality of optical transmission bodies, the optical connector being configured to engage with another optical connector that holds another plurality of optical transmission bodies to optically couple the plurality of optical transmission bodies with the other plurality of optical transmission bodies, the other optical connector having a shape identical with a shape of the optical connector, the optical connector comprising:
the plurality of optical transmission bodies; and
a ferrule that holds the plurality of optical transmission bodies disposed in parallel to each other in a first direction,
wherein the ferrule includes:
a holding section that holds the plurality of optical transmission bodies,
a first surface disposed to face end surfaces of the plurality of optical transmission bodies held by the holding section, the first surface allowing thereon incidence of light emitted from the plurality of optical transmission bodies or allowing therefrom emission of light toward the plurality of optical transmission bodies, and
a plurality of second surfaces that allow therefrom emission of the light incident on the first surface toward the other optical connector or allow thereon incidence of light from the other optical connector,
wherein the end surfaces of the plurality of optical transmission bodies are each inclined with respect to a second direction perpendicular to the first direction when the end surfaces are viewed along the first direction,
wherein in a cross section that is along the second direction and includes a first center axis of any one second surface of the plurality of second surfaces and a second center axis of one optical transmission body among the plurality of optical transmission bodies, the one optical transmission body corresponding to the second surface,
the first center axis and the second center axis are disposed closer to a tip end of the one optical transmission body than a fitting centerline is, and
wherein under an assumption that the optical connector is engaged with the other optical connector and that the first center axis and the second center axis are positioned on an identical straight line, when a third reference straight line is defined as a straight line positioned on the first center axis and the second center axis,
in the optical connector, the third reference straight line is positioned in the cross section between the first center axis and the second center axis in such a way that optical coupling efficiency between the plurality of optical transmission bodies and the other plurality of optical transmission bodies is maximized.

2. The optical connector according to claim 1, wherein
the ferrule further includes at least one pair of movement prevention sections for restricting movement with respect to the other optical connector in the second direction perpendicular to the first direction, the at least one pair of movement prevention sections being disposed in positions in such a way that each of movement prevention sections is linearly symmetrical with respect to a first reference straight line parallel to the first direction when each of the movement prevention sections is viewed along an optical path between the optical connector and the other optical connector, the at least one pair of movement prevention sections being fitted to the other optical connector directly or via another member, the movement prevention sections being the at least one pair of movement prevention sections and
the fitting centerline is at a center of one of the movement prevention members.

3. The ferrule used for the optical connector according to claim 1.

4. An optical connector module, comprising:
the optical connector according to claim 1.

5. The ferrule used for the optical connector according to claim 2.

6. An optical connector module, comprising:
the optical connector according to claim 2.
